(19) United States
(12) Patent Application Publication
(10) Pub. No.: US 2026/0277130 A1
(43) Pub. Date: Sep. 17, 2026

(54) DEVELOPMENT ROLL FOR ELECTROPHOTOGRAPHIC EQUIPMENT

(71) Applicant: Sumitomo Riko Company Limited, Aichi (JP)

(72) Inventors: Takehito Ohya, Aichi (JP); Keiichi Inoue, Aichi (JP); Toshihiko Arata, Aichi (JP); Shuto Akama, Aichi (JP); Naoki Akira, Aichi (JP)

(73) Assignee: Sumitomo Riko Company Limited, Aichi (JP)

(21) Appl. No.: 19/667,659

(22) Filed: May 5, 2026

Related U.S. Application Data
(63) Continuation of application No. PCT/JP2025/003497, filed on Feb. 4, 2025.

(30) Foreign Application Priority Data
Feb. 23, 2024 (JP) 2024-026065

(51) Int. Cl. G03G 15/08; C08K 3/04; C08K 5/56; C08L 75/06

(52) U.S. Cl. CPC G03G 15/0818; C08K 3/04; C08K 5/56; C08L 75/06; G03G 2215/0861

(57) ABSTRACT

This development roll (10) for an electrophotographic apparatus comprises: a shaft body (12); an elastic body layer (14) that is formed on the outer peripheral surface of the shaft body (12); and a surface layer (16) that is formed on the outer peripheral surface of the elastic body layer (14). The elastic body layer (14) is composed of a silicone base material that contains silicone rubber. The surface layer 16 is composed of a crosslinked body of a composition that contains a urethane prepolymer which is composed of the substances (A) and (B) described below, and the substances (C) to (E) described below. The breaking stress of the surface layer (16) is 30 MPa or more. (A) An aromatic isocyanate, (B) A caprolactone-based polyol or a carbonate-based polyol, (C) Carbon black, (D) A (meth)acrylic polymer that contains a hydrophilic group and a silicone group in each molecule, (E) An isocyanurate

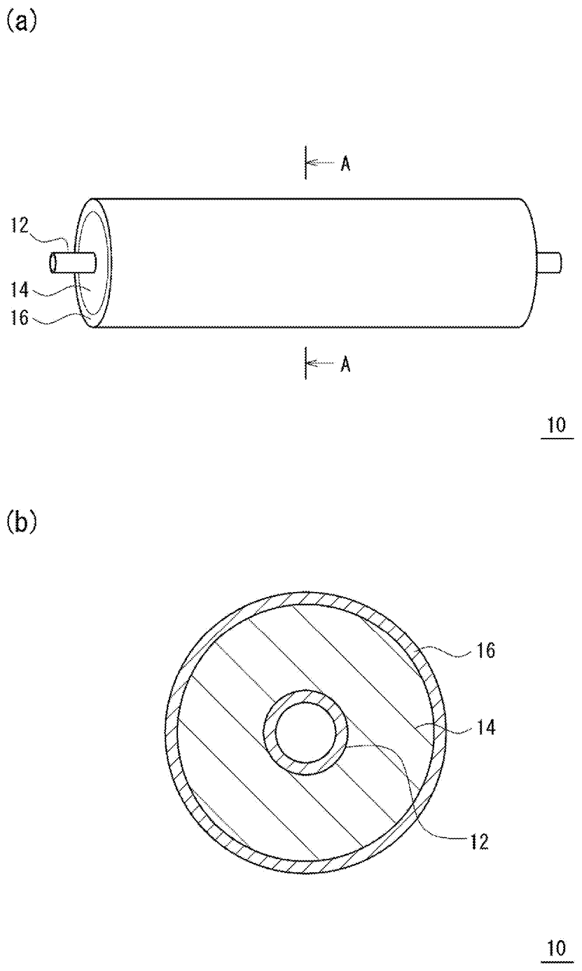

### CROSS-REFERENCE TO RELATED APPLICATION

This application is a continuation of PCT International Application No. PCT/JP2025/003497, filed on Feb. 4, 2025, which claims priority under 35 U.S.C § 119(a) to Japanese Patent Application No. 2024-026065, filed on Feb. 23, 2024. Each of the above applications is hereby expressly incorporated by reference, in its entirety, into the present application.

### TECHNICAL FIELD

The disclosure relates to a development roll for an electrophotographic apparatus that is suitably used in an electrophotographic apparatus such as a copier, a printer, and a facsimile that adopt an electrophotographic method.

### RELATED ART

A development roll of an electrophotographic apparatus is known to have a configuration including a shaft body formed by a core metal or the like, an elastic body layer formed on the outer peripheral surface of the shaft body, and a surface layer formed on the outer peripheral surface of the elastic body layer. The surface layer is formed of a urethane material containing a conductive agent or the like. Carbon black or the like is used as the conductive agent.

### PRIOR ART DOCUMENT(S)

### Patent Document(s)

Patent Document 1: Japanese Patent Application Laid-Open Publication No. 2001-310998

With the surface layer of the development roll containing a large amount of carbon black, the surface layer has low electrical resistance, resulting in a favorable image. On the other hand, the surface layer becomes brittle and prone to wear, resulting in deterioration of durability. For this reason, achieving low electrical resistance and strength in the surface layer is a challenge. In addition, the electrical resistance of the surface layer is also affected by the uniformity of the surface layer. When the surface layer is uniform, the electrical resistance and chargeability of the surface layer are stabilized, resulting in a favorable image. Therefore, the uniformity of the surface layer is also important.

An issue to be solved by the disclosure is to provide a development roll for an electrophotographic apparatus in which the surface layer has a low electrical resistance, excels in wear resistance and uniformity, and excels in image quality over a long period of time.

### SUMMARY

A development roll for an electrophotographic apparatus according to the disclosure includes: a shaft body; an elastic body layer, formed on an outer peripheral surface of the shaft body; and a surface layer, formed on an outer peripheral surface of the elastic body layer. The elastic body layer is formed of a silicone base material containing silicone rubber. The surface layer is formed of a crosslinked body of a composition containing a urethane prepolymer formed of (A) and (B) as follows and (C) to (E) as follows, and the surface layer has a breaking stress of 30 MPa or more:
(A) aromatic isocyanate;
(B) caprolactone-based polyol or carbonate-based polyol;
(C) carbon black;
(D) (meth)acrylic polymer containing a hydrophilic group and a silicone group in a molecule; and
(E) isocyanurate.

### BRIEF DESCRIPTION OF DRAWINGS

In the FIGURE, (a) is a schematic external view of a development roll for an electrophotographic apparatus according to an embodiment of the disclosure, and (b) is a cross-sectional view taken along a line A-A thereof.

### DESCRIPTION OF EMBODIMENTS

A development roll for an electrophotographic apparatus according to the disclosure includes: a shaft body; an elastic body layer, formed on an outer peripheral surface of the shaft body; and a surface layer, formed on an outer peripheral surface of the elastic body layer. The elastic body layer is formed of a silicone base material containing silicone rubber. The surface layer is formed of a crosslinked body of a composition containing a urethane prepolymer formed of (A) and (B) as follows and (C) to (E) as follows, and the surface layer has a breaking stress of 30 MPa or more:
(A) aromatic isocyanate;
(B) caprolactone-based polyol or carbonate-based polyol;
(C) carbon black;
(D) (meth)acrylic polymer containing a hydrophilic group and a silicone group in a molecule; and
(E) isocyanurate.

A weight average molecular weight Mw of the urethane prepolymer may be 100,000 or more and 300,000 or less. (A) may be diphenylmethane diisocyanate. A content of (C) may be 10 parts by mass or more and 35 parts by mass or less with respect to 100 parts by mass of the urethane prepolymer. A content of (D) may be 1.0 part by mass or more and 20 parts by mass or less with respect to 100 parts by mass of the urethane prepolymer. A content of (E) may be 1.0 part by mass or more and 40 parts by mass or less with respect to 100 parts by mass of the urethane prepolymer. An electrical resistance of the surface layer may be 1.0×10³Ω or more and 1.0×10⁶Ω or less. The hydrophilic group of (D) may be an amino group or a hydroxy group. The surface layer may further contain a carbon black dispersant having an aromatic ring.

(1) A development roll for an electrophotographic apparatus includes: a shaft body; an elastic body layer, formed on an outer peripheral surface of the shaft body; and a surface layer, formed on an outer peripheral surface of the elastic body layer. The elastic body layer is formed of a silicone base material containing silicone rubber, the surface layer is formed of a crosslinked body of a composition containing a urethane prepolymer composed of (A) and (B) as follows and (C) to (E) as follows, and the surface layer has a breaking stress of 30 MPa or more:
(A) aromatic isocyanate;
(B) caprolactone-based polyol or carbonate-based polyol;
(C) carbon black;
(D) (meth)acrylic polymer containing a hydrophilic group and a silicone group in a molecule; and
(E) isocyanurate.

(2) In (1) above, a weight average molecular weight Mw of the urethane prepolymer may be 100,000 or more and 300,000 or less.

(3) In (1) or (2) above, (A) may be diphenylmethane diisocyanate.

(4) In any one of (1) to (3) above, a content of (C) may be 10 parts by mass or more and 35 parts by mass or less with respect to 100 parts by mass of the urethane prepolymer.

(5) In any one of (1) to (4) above, a content of (D) may be 1.0 part by mass or more and 20 parts by mass or less with respect to 100 parts by mass of the urethane prepolymer.

(6) In any one of (1) to (5) above, a content of (E) may be 1.0 part by mass or more and 40 parts by mass or less with respect to 100 parts by mass of the urethane prepolymer.

(7) In any one of (1) to (6) above, an electrical resistance of the surface layer may be 1.0×10³Ω or more and 1.0×10⁶Ω or less.

(8) In any one of (1) to (7) above, the hydrophilic group of (D) may be an amino group or a hydroxy group.

(9) In any one of (1) to (8) above, the surface layer may further contain a carbon black dispersant having an aromatic ring.

### Effects of Disclosure

According to the development roll for the electrophotographic apparatus according to the disclosure, the elastic body layer is formed of the silicone base material containing silicone rubber, the surface layer is formed of the crosslinked body of the composition containing the urethane prepolymer formed of (A) and (B) above and (C) to (E) above, and the breaking stress of the surface layer is 30 MPa or more. Therefore, the surface layer has a low electrical resistance and is excellent in wear resistance as well as excellent in uniformity, and is excellent in images over a long period of time.

Here, when the weight average molecular weight Mw of the urethane prepolymer is 100,000 or more and 300,000 or less, the strength of the surface layer is excellent, and the wear resistance of the surface layer is excellent.

In addition, when (A) is diphenylmethane diisocyanate, the wear resistance of the surface layer is improved because diphenylmethane diisocyanate is particularly excellent in the effect of improving the strength among aromatic isocyanates.

In addition, when the content of (C) is 10 parts by mass or more and 35 parts by mass or less with respect to 100 parts by mass of the urethane prepolymer, a low electrical resistance and a wear resistance can be achieved outstandingly.

In addition, when the content of (D) is 1.0 part by mass or more and 20 parts by mass or less with respect to 100 parts by mass of the urethane prepolymer, the effect of improving the uniformity of the surface layer is excellent.

In addition, when the content of (E) is 1.0 part by mass or more and 40 parts by mass or less with respect to 100 parts by mass of the urethane prepolymer, the wear resistance of the surface layer is improved because the effect of improving strength is excellent.

In addition, when the electrical resistance of the surface layer is 1.0×10³Ω or more and 1.0×10⁶Ω or less, the electrical resistance is low and the image is excellent.

In addition, when the hydrophilic group of (D) is an amino group or a hydroxy group, the effect of improving the uniformity of the surface layer is excellent.

In addition, when the surface layer further contains a carbon black dispersant having an aromatic ring, the dispersibility of the carbon black is improved.

A development roll for an electrophotographic apparatus according to the disclosure (hereinafter, may be simply referred to as a development roll) is described in detail. In the FIGURE, (a) is a schematic external view of a development roll for an electrophotographic apparatus according to an embodiment of the disclosure, and (b) is a cross-sectional view taken along a line A-A thereof.

A development roll 10 includes a shaft body 12, an elastic body layer 14 formed on the outer peripheral surface of the shaft body 12, and a surface layer 16 formed on the outer peripheral surface of the elastic body layer 14. The elastic body layer 14 is a layer (base layer) that serves as a base of the development roll 10. The surface layer 16 is a layer that appears on the surface of the development roll 10.

The shaft body 12 is not particularly limited as long as it has conductivity. Specifically, examples include a solid body made of metal such as iron, stainless steel, or aluminum, and a core metal made of a hollow body. An adhesive, a primer, or the like may be applied to the surface of the shaft body 12 as needed. That is, the elastic body layer 14 may be bonded to the shaft body 12 via an adhesive layer (primer layer). The adhesive, primer, or the like may be made conductive as needed.

The elastic body layer 14 is formed by a silicone base material containing silicone rubber. Silicone rubber is a material having excellent elastic recovery force, and is a material that is less likely to undergo a volume change in response to an environmental change such as temperature change or humidity change, and has small environmental change. Therefore, the outer diameter fluctuation of the development roll 10 due to an environmental change becomes small, and the toner conveyance amount is easily stabilized. Silicone rubber includes those prepared by mixing two liquids, thermosetting types, and the like.

Various additives such as a conductive agent, a filler, an extender, a reinforcing agent, a processing aid, a curing agent, a vulcanization accelerator, a crosslinking agent, a crosslinking aid, an antioxidant, a plasticizer, an ultraviolet absorber, a pigment, a silicone oil, an auxiliary agent, and a surfactant are appropriately added to the elastic body layer 14 as needed. As the conductive agent, a general conductive agent such as an electronic conductive agent such as carbon black or an ionic conductive agent such as a quaternary ammonium salt can be used.

The elastic body layer 14 may be a foam or a solid body. The thickness of the elastic body layer 14 is preferably in a range of 0.1 mm to 10 mm. More preferably, the thickness may be in a range of 1 mm to 5 mm.

The surface layer 16 is formed by a crosslinked body of a composition containing a urethane prepolymer formed by (A) and (B) as follows, and (C) to (E) as follows.
(A) Aromatic isocyanate
(B) Caprolactone-based polyol or carbonate-based polyol
(C) Carbon black
(D) (Meth)acrylic polymer containing a hydrophilic group and a silicone group in the molecule
(E) Isocyanurate

The aromatic isocyanate of (A) is an isocyanate in which an isocyanate group is covalently bonded to an aromatic ring. By using an aromatic isocyanate as the isocyanate, toughness can be imparted to the surface layer 16 containing the urethane prepolymer. Examples of the aromatic isocyanate include diphenylmethane diisocyanate (MDI), polymethylene polyphenylene polyisocyanate (polymeric MDI), crude MDI (c-MDI) which is a mixture of MDI and polymeric MDI, tolylene diisocyanate (TDI), ortho-tolidine diisocyanate (TODI), naphthylene diisocyanate (NDI), and paraphenylene diisocyanate (PDI). Among these, MDI, polymeric MDI, and crude MDI are more preferable from the viewpoint of being more excellent in the effect of enhancing toughness.

The polyol of (B) is a caprolactone-based polyol or a carbonate-based polyol. By using these as the polyol of (B), the strength of the surface layer 16 containing the urethane prepolymer can be enhanced as compared to other polyols such as ether polyols and ester polyols. These may be used alone as the polyol of (B), or two or more types may be used in combination. Between the caprolactone-based polyol or the carbonate-based polyol, the caprolactone-based polyol is more preferable from the viewpoint of being more excellent in the effect of enhancing the strength of the surface layer 16.

The weight average molecular weight Mw of the urethane prepolymer is preferably 100,000 or more and 300,000 or less. With the molecular weight being a high molecular weight of 100,000 or more, toughness is improved, and more excellent toughness can be imparted to the surface layer 16 containing the urethane prepolymer. As a result, the surface layer 16 is excellent in strength, and the surface layer 16 is excellent in wear resistance. From this viewpoint, the molecular weight is more preferably 150,000 or more, and further preferably 200,000 or more. When the molecular weight is 300,000 or less, an increase in viscosity of the prepolymer can be suppressed, and moldability can be improved. From this viewpoint, the molecular weight is more preferably 280,000 or less, and further preferably 250,000 or less. The weight average molecular weight (Mw) is a weight average molecular weight in terms of standard polystyrene molecular weight, and is measured by a GPC measuring instrument (manufactured by Shimadzu Corporation, detector: RI, column: TSKgel GMHxl (2 columns), TSKgel G1000Hxl, mobile phase: THF). A urethane prepolymer/THF solution (solution concentration: 0.3%) is used as a measurement sample.

The carbon black of (C) is used as a conductive agent. The carbon black is not particularly limited as long as it is excellent in conductivity. As the carbon black, Ketjen Black (registered trademark) and the like are preferable from the viewpoint of being excellent in conductivity.

The carbon black of (C) contributes to a low electrical resistance of the surface layer 16. When the carbon black amount becomes excessively large, the surface layer 16 becomes brittle and tends to wear, and the durability thereof deteriorates. The content of the carbon black is preferably 10 parts by mass or more and 35 parts by mass or less with respect to 100 parts by mass of the urethane prepolymer, from the viewpoint of achieving both low electrical resistance and wear resistance outstandingly. More preferably, the content is 12 parts by mass or more and 25 parts by mass or less.

At the time of forming the surface layer 16, the carbon black of (C) may be blended into the surface layer forming composition in a state of being dispersed in a solvent, from the viewpoint of improving dispersibility. In this case, a carbon black dispersant may be used for the carbon black of (C). Examples of the carbon black dispersant include ionic surfactants, nonionic surfactants, and transition metal complexes. Among these, a carbon black dispersant having an aromatic ring is particularly preferable. The dispersant can exhibit excellent dispersibility because of its high adsorptivity to the surface of carbon black due to π-π electron interaction.

Examples of the carbon black dispersant having an aromatic ring include a dispersant formed of a transition metal complex having an aromatic ring. Examples of the dispersant formed of a transition metal complex having an aromatic ring include zinc compounds, cobalt compounds, and copper compounds having a porphyrin or phthalocyanine structure. Among these, a copper compound having an aromatic ring is preferable because it is inexpensive and has high dispersing ability.

The content of the carbon black dispersant is preferably 1.0 part by mass or more with respect to 100 parts by mass of the urethane prepolymer, from the viewpoint of dispersibility of the carbon black. More preferably, the content of the carbon black is 5.0 parts by mass or more, and still more preferably, the content of the carbon black is 10 parts by mass or more. On the other hand, from the viewpoint of suppressing deterioration of physical properties accompanying an increase in the carbon black dispersant, the content of the carbon black dispersant is preferably 30 parts by mass or less with respect to 100 parts by mass of the urethane prepolymer. More preferably, the content of the carbon black is 25 parts by mass or less.

(D) is a (meth)acrylic polymer containing a hydrophilic group and a silicone group in the molecule. (D) can contribute to reducing friction on the surface of the surface layer 16 by having a silicone group. In addition, since (D) has a hydrophilic group, it tends to be dispersed also inside the surface layer 16 due to affinity with the urethane prepolymer. Furthermore, by using a urethane prepolymer with a high molecular weight, (D) tends to remain inside the surface layer 16 and tends to be dispersed also inside the surface layer 16. This can also improve uniformity of the surface layer 16.

The (meth)acrylic polymer is an acrylic polymer or a methacrylic polymer. The silicone group is a group having a siloxane bond. Examples of the siloxane bond include dimethylsiloxane, methylphenylsiloxane, and diphenylsiloxane. Examples of the hydrophilic group include an amino group, a hydroxy group, an ether group, an ester group, an amide group, an imide group, a carboxyl group, a sulfo group, a silanol group, and a mercapto group. Among the hydrophilic groups, an amino group and a hydroxy group are particularly preferable from the viewpoint of being excellent in the effect of improving uniformity of the surface layer 16.

(D) can be obtained, for example, by copolymerizing a polymerizable (meth)acrylic compound having a hydrophilic group, a polymerizable (meth)acrylic compound having a silicone group, and a polymerizable (meth)acrylic compound having neither a hydrophilic group nor a silicone group that is added as needed. Examples of the polymerizable (meth)acrylic compound include (meth)acrylic monomers and (meth)acrylic oligomers. Examples of the (meth)acrylic monomer include (meth)acrylic acid, (meth)acrylic acid ester, and (meth)acrylamide.

As the polymerizable (meth)acrylic compound having a hydrophilic group, (meth)acrylic acid ester and (meth)acrylamide are preferable, and (meth)acrylamide is more preferable.

Examples of the polymerizable (meth)acrylic compound having an amino group as a hydrophilic group include dimethylaminopropyl (meth)acrylamide, dimethylaminomethyl (meth)acrylamide, dimethylaminoethyl (meth)acrylamide, dimethylaminobutyl (meth)acrylamide, dimethylaminohexyl (meth)acrylamide, dimethylaminoheptyl (meth)acrylamide, dimethylaminooctyl (meth)acrylamide, diethylaminopropyl (meth)acrylamide, diphenylaminopropyl (meth)acrylamide, aminopropyldimethyl (meth)acrylamide, hydroxyaminopropyldimethyl (meth)acrylamide, diaminomethyl (meth)acrylamide, triaminopropyl (meth)acrylamide, diethyl (meth)acrylamide, (meth)acrylamide, and isopropyl (meth)acrylamide.

Examples of the polymerizable (meth)acrylic compound having a silicone group include (meth)acryl-modified silicone compounds.

Examples of the polymerizable (meth)acrylic compound having neither a hydrophilic group nor a silicone group include polymerizable (meth)acrylic compounds having a fluorine-containing group, and alkyl (meth)acrylates. Examples of the fluorine-containing group include fluoroalkyl groups, fluoroalkylalkylene oxide groups, fluoroalkenyl groups, and —F. Those having a fluorine-containing group can improve the toner release property of the surface of the surface layer 16. Alkyl (meth)acrylate makes it easy to control the molecular weight of the entire (D)

Examples of the polymerizable (meth)acrylic compound having a fluorine-containing group include 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, 2-(perfluoro-3-methylbutyl)ethyl (meth)acrylate, 2-(perfluoro-5-methylhexyl)ethyl (meth)acrylate, 2-(perfluoro-7-methyloctyl)ethyl (meth)acrylate, 1H,1H,3H-tetrafluoropropyl (meth)acrylate, 1H,1H,5H-octafluoropentyl (meth)acrylate, 1H,1H,7H-dodecafluoroheptyl (meth)acrylate, 1H,1H,9H-hexadecafluorononyl (meth)acrylate, 1H-1-(trifluoromethyl)trifluoroethyl (meth)acrylate, 1H, 1H,3H-hexafluorobutyl (meth)acrylate, 3-perfluorobutyl-2-hydroxypropyl (meth)acrylate, 3-perfluorohexyl-2-hydroxypropyl (meth)acrylate, 3-perfluorooctyl-2-hydroxypropyl (meth)acrylate, 3-(perfluoro-3-methylbutyl)-2-hydroxypropyl (meth)acrylate, 3-(perfluoro-5-methylhexyl)-2-hydroxypropyl (meth)acrylate, and 3-(perfluoro-7-methyloctyl)-2-hydroxypropyl (meth)acrylate.

Examples of alkyl (meth)acrylate include methyl (meth)acrylate, ethyl (meth)acrylate, and butyl (meth)acrylate.

The content of (D) is preferably 1.0 part by mass or more with respect to 100 parts by mass of the urethane prepolymer, from the viewpoint of being excellent in the effect of improving the uniformity of the surface layer 16. More preferably, the content of (D) is 2.0 parts by mass or more, and further preferably 5.0 parts by mass or more. On the other hand, from the viewpoint of suppressing deterioration of physical properties accompanying an increase in (D), the content of (D) is preferably 20 parts by mass or less with respect to 100 parts by mass of the urethane prepolymer. More preferably, the content of (D) is 15 parts by mass or less, and further preferably 10 parts by mass or less.

The isocyanurate of (E) is a compound having an isocyanurate ring. The isocyanurate of (E) is formed of a trimer of diisocyanate and is a compound having three isocyanate functional groups in addition to the isocyanurate ring. In the isocyanurate of (E), the isocyanate functional groups react with the hydrophilic group of (D), and the isocyanurate functions as a crosslinking agent for (D). This allows (D) to easily remain inside the surface layer 16, thereby contributing to the uniformity of the surface layer 16 together with (D). In addition, the crosslinking of (D) also contributes to improvement and maintenance of strength. Furthermore, toner chargeability can be improved by the nitrogen atoms within the cyclic structure of the isocyanurate ring.

The isocyanurate of (E) is not particularly limited as long as it is formed of a trimer of diisocyanate. The diisocyanate forming the isocyanurate of (E) may be an aliphatic isocyanate or an aromatic isocyanate. As the diisocyanate forming the isocyanurate of (E), an aliphatic isocyanate not containing an aromatic ring is more preferable.

Examples of the diisocyanate forming the isocyanurate of (E) include diphenylmethane diisocyanate (MDI), dicyclohexylmethane diisocyanate (hydrogenated MDI), tolylene diisocyanate (TDI), hexamethylene diisocyanate (HDI), trimethylhexamethylene diisocyanate (TMHDI), isophorone diisocyanate (IPDI), ortho-toluidine diisocyanate (TODI), naphthylene diisocyanate (NDI), xylylene diisocyanate (XDI), paraphenylene diisocyanate (PDI), lysine diisocyanate methyl ester (LDI), and dimethyl diisocyanate (DDI). Among these, dicyclohexylmethane diisocyanate (hydrogenated MDI), hexamethylene diisocyanate (HDI), trimethylhexamethylene diisocyanate (TMHDI), and dimethyl diisocyanate (DDI) are preferable.

Examples of the aliphatic isocyanurate include 1,3,5-tris(6-isocyanatohex-1-yl)-1,3,5-triazine-2,4,6(1H,3H,5H)-trione, 1,3,5-tris (6-isocyanatotetra-1-yl)-1,3,5-triazine-2,4,6(1H,3H,5H)-trione, and 1,3,5-tris (6-isocyanatododeca-1-yl)-1,3,5-triazine-2,4,6(1H,3H,5H)-trione.

The content of the isocyanurate of (E) is preferably 1.0 part by mass or more with respect to 100 parts by mass of the urethane prepolymer, from the viewpoints of contributing to the uniformity of the surface layer 16, contributing to the improvement and maintenance of strength, and improving toner chargeability. More preferably, the content of the isocyanurate of (E) is 5.0 parts by mass or more, and still more preferably 10 parts by mass or more. On the other hand, from the viewpoint of deterioration of physical properties accompanying an increase in the isocyanurate of (E), the content of the isocyanurate of (E) is preferably 40 parts by mass or less with respect to 100 parts by mass of the urethane prepolymer. More preferably, the content of the isocyanurate of (E) is 30 parts by mass or less, and still more preferably 20 parts by mass or less.

The surface layer 16 may also contain, as needed, various additives such as urethane reaction catalysts, urethane crosslinking agents, urethane chain extenders, fillers (inorganic and organic), silane coupling agents, dispersants, leveling agents, crosslinking agents, crosslinking aids, plasticizers, flame retardants, defoaming agents, roughness forming particles, and conductive agents. These may be used alone or in combination of two or more.

Examples of the conductive agent include electronic conductive agents other than carbon black, and ionic conductive agents. The conductive agent may be only an electronic conductive agent, may be only an ionic conductive agent, or may be a combination of an electronic conductive agent and an ionic conductive agent.

Examples of the electronic conductive agent include graphite, and conductive oxides such as conductive titanium oxide, conductive zinc oxide, and conductive tin oxide. Although not particularly limited, these may be used alone as an electronic conductive agent, or may be used in combination of two or more.

The ionic conductive agent is not particularly limited. Any ionic conductive agent used in the field of electrophotographic apparatus may be used. Examples of the ionic conductive agent include quaternary ammonium salts, quaternary phosphonium salts, imidazolium salts, borates, and surfactants. Among these, quaternary ammonium salts, quaternary phosphonium salts, and imidazolium salts are preferred, and imidazolium salts are particularly preferred.

Examples of the cation of the quaternary ammonium salt include those having one or more alkyl groups or aryl groups having about 1 to 18 carbon atoms (such as methyl group, ethyl group, propyl group, butyl group, hexyl group, octyl group, decyl group, phenyl group, and xylyl group). The alkyl group or aryl group of the cation of the quaternary ammonium salt particularly preferably has 1 to 10 carbon atoms. Examples of the anion of the quaternary ammonium salt include halogen ions such as F⁻, Cl⁻, Br⁻, and I⁻, ClO₄⁻, BF₄⁻, PF₆⁻, SO₄²⁻, HSO₄⁻, C₂H₅SO₄⁻, CF₃COO⁻, CF₃SO₃⁻, (CF₃SO₂)₂N⁻, (CF₃CF₂SO₂)₂N⁻, CF₃(CF₂)₃SO₃⁻, (CF₃SO₂)₃C⁻, and CF₃(CF₂)₂COO⁻. As the anion of the quaternary ammonium salt, CIO₄⁻, PF₆⁻, (CF₃SO₂)₂N⁻, and CF₃SO₃⁻ are more preferred.

Examples of the cation of the quaternary phosphonium salt include those having one or more alkyl groups or aryl groups having about 1 to 18 carbon atoms (such as methyl group, ethyl group, propyl group, butyl group, hexyl group, octyl group, decyl group, phenyl group, and xylyl group). The alkyl group or aryl group of the cation of the quaternary phosphonium salt particularly preferably has 1 to 10 carbon atoms. Examples of the anion of the quaternary phosphonium salt include halogen ions such as F⁻, Cl⁻, Br⁻, and I⁻, ClO₄⁻, BF₄⁻, PF₆⁻, SO₄²⁻, HSO₄⁻, C₂H₅SO₄⁻, CF₃COO⁻, CF₃SO₃⁻, (CF₃SO₂)₂N⁻, (CF₃CF₂SO₂)₂N⁻, CF₃(CF₂)₃SO₃⁻, (CF₃SO₂)₃C⁻, and CF₃ (CF₂)₂COO⁻. As the anion of the quaternary phosphonium salt, CIO₄⁻, PF₆⁻, (CF₃SO₂)₂N⁻, and CF₃SO₃⁻ are more preferred.

Examples of the imidazolium salt include unsubstituted imidazolium salts, 1-alkylimidazolium salts, 3-alkylimidazolium salts, 1,3-dialkylimidazolium salts, and 1,2,3-trialkylimidazolium salts. More specifically, examples include 1-methylimidazolium salt, 1,3-dimethylimidazolium salt, 1,3-diethylimidazolium salt, 1,3-dipropylimidazolium salt, 1,3-dibutylimidazolium salt, 1,3-dicyclohexylimidazolium salt, 1-ethyl-3-methylimidazolium salt, 1-propyl-3-methylimidazolium salt 1-butyl-3-methylimidazolium salt, 1-hexyl-3-methylimidazolium salt, 1-ethyl-2,3-dimethylimidazolium salt, 1-propyl-2,3-dimethylimidazolium salt, and 1-butyl-2,3-dimethylimidazolium salt. Examples of the anion of the imidazolium salt include halogen ions such as F⁻, Cl⁻, Br⁻, and I⁻, ClO₄⁻, BF₄⁻, PF₆⁻, SO₄²⁻, HSO₄⁻, C₂H₅SO₄⁻, CF₃COO⁻, CF₃SO₃⁻, (CF₃SO₂)₂N⁻, (CF₃CF₂SO₂)₂N⁻, CF₃ (CF₂)₃SO₃⁻, (CF₃SO₂)₃C⁻, and CF₃ (CF₂)₂COO⁻. As the anion of the imidazolium salt, ClO₄⁻, PF₆⁻, (CF₃SO₂)₂N⁻, and CF₃SO₃⁻ are more preferred.

Examples of the borate include those having one or more alkyl groups or aryl groups having about 1 to 18 carbon atoms (such as methyl group, ethyl group, propyl group, butyl group, hexyl group, octyl group, decyl group, phenyl group, and xylyl group) and containing alkali metal ions or alkaline earth metal ions such as lithium ion, sodium ion, potassium ion, and calcium ion.

The content of the ionic conductive agent is preferably 0.1 parts by mass or more with respect to 100 parts by mass of the urethane prepolymer from the viewpoint of low electrical resistance and the like. More preferably, the content of the ionic conductive agent is 0.5 parts by mass or more, and still more preferably 1.0 parts by mass or more. In addition, from the viewpoint of easily suppressing bleeding of the ionic conductive agent and the like, the content is preferably 20 parts by mass or less with respect to 100 parts by mass of the urethane prepolymer. More preferably, the content is 15 parts by mass or less, and still more preferably 13 parts by mass or less.

Examples of the silane coupling agent include mercapto-based silane coupling agents, sulfide-based silane coupling agents, amine-based silane coupling agents, epoxy-based silane coupling agents, and vinyl-based silane coupling agents. Among these, mercapto-based silane coupling agents are more preferable from the viewpoints of improving the adhesive strength between the elastic body layer 14 containing a silicone polymer and the surface layer 16 containing a urethane prepolymer, and being capable of forming a bond with the isocyanurate of (E).

Examples of the mercapto-based silane coupling agent include 3-mercaptopropyltrimethoxysilane and 3-mercaptopropyltriethoxysilane. Examples of the sulfide-based silane coupling agent include bis-(3-(triethoxysilyl)-propyl)-disulfide and bis(3-triethoxysilylpropyl)trisulfide. Examples of the amine-based silane coupling agent include 3-aminopropyltriethoxysilane and 3-aminopropyltrimethoxysilane. Examples of the epoxy-based silane coupling agent include 2-(3,4-epoxycyclohexyl)ethyltrimethoxysilane and 3-glycidoxypropyltrimethoxysilane. Examples of the vinyl-based silane coupling agent include vinyltriethoxysilane and vinyltrimethoxysilane.

The content of the silane coupling agent is preferably 0.1 parts by mass or more and 10 parts by mass or less with respect to 100 parts by mass of the urethane prepolymer. More preferably, the content is 0.5 parts by mass or more and 8.0 parts by mass or less, and still more preferably 1.0 parts by mass or more and 5.0 parts by mass or less.

The roughness forming particles are particles for imparting roughness to the surface of the surface layer 16. In other words, the roughness forming particles are particles for imparting unevenness to the surface of the surface layer 16. The surface unevenness of the surface layer 16 can improve toner adhesion and toner conveyance amount.

Examples of the material of the roughness forming particles include urethane resin, polyamide resin, (meth)acrylic resin, (meth)acrylic silicone resin, silicone-grafted (meth)acrylic polymer, (meth)acrylic-grafted silicone polymer, urethane rubber, and silica. Among these, urethane resin and urethane rubber are more preferable.

The size of the roughness forming particles is not particularly limited, but from the viewpoint of ease of ensuring uniform developability, those having an average particle diameter of 3.0 μm or more and 50 μm or less are preferable. More preferably, those having an average particle diameter of 5.0 μm or more and 30 μm or less are preferable. The average particle diameter of the roughness forming particles is determined by observing the surface of the surface layer 16 with a laser microscope, taking the diameter of the roughness forming particles visible during surface observation as the particle diameter, and expressing it as an average of arbitrary 20 points.

The content of the roughness forming particles is preferably 3.0 parts by mass or more and 50 parts by mass or less with respect to 100 parts by mass of the urethane prepolymer, from the viewpoint of ease of ensuring uniform developability. More preferably, the content is 5.0 parts by mass or more and 30 parts by mass or less.

The surface layer 16 has a breaking stress of 30 MPa from the viewpoint of ensuring excellent wear resistance. When the breaking stress is less than 30 MPa, the wear resistance is not satisfied, and durability decreases. From the above viewpoint, the breaking stress of the surface layer 16 is more preferably 35 MPa or more, and still more preferably 40 MPa or more. On the other hand, from the viewpoint of ease of manufacturing, the breaking stress of the surface layer 16 is preferably 60 MPa or less. More preferably, the breaking stress is 55 MPa or less, and still more preferably 50 MPa or less. The breaking stress of the surface layer 16 is influenced by the molecular weight of the urethane prepolymer, the carbon black amount, the acrylic polymer amount, the isocyanurate amount, and the like. For example, the larger the molecular weight of the urethane prepolymer, the larger the breaking stress of the surface layer 16 becomes. When the carbon black amount, the acrylic polymer amount, the isocyanurate amount, and the like become excessively large, the breaking stress of the surface layer 16 becomes smaller due to deterioration of physical properties. Taking these into consideration, the breaking stress of the surface layer 16 can be adjusted. The breaking stress of the surface layer 16 can be measured by performing a tensile test on a test piece in a laminated state of the elastic body layer 14 and the surface layer 16.

The thickness of the surface layer 16 is not particularly limited, but is preferably 1.0 μm or more and 20 μm or less, and more preferably 3.0 μm or more and 15 μm or less.

The electrical resistance of the surface layer 16 is preferably 1.0×10³Ω or more and 1.0×10⁶Ω or less, from the viewpoint of low electrical resistance and excellent image quality.

More preferably, the electrical resistance is 1.0×10³Ω or more and 1.0×10⁵Ω or less. The electrical resistance of the surface layer 16 can be adjusted by the blending amount of carbon black, ionic conductive agent, and the like.

The development roll 10 can be produced by forming the elastic body layer 14 on the outer peripheral surface of the shaft body 12, and forming the surface layer 16 on the outer peripheral surface of the elastic body layer 14.

The elastic body layer 14 can be formed, for example, as follows. First, the shaft body 12 is coaxially placed in a hollow portion of a roll molding die, an uncrosslinked elastic body layer forming material is injected, and after heating and curing (crosslinking), the mold is removed. Alternatively, the elastic body layer 14 is formed on the outer periphery of the shaft body 12 by extrusion molding an uncrosslinked elastic body layer forming material on the surface of the shaft body 12.

To form the surface layer 16, a surface layer forming composition is used. The surface layer forming composition may appropriately contain a solvent such as an organic solvent including methyl ethyl ketone, toluene, acetone, ethyl acetate, butyl acetate, methyl isobutyl ketone (MIBK), THF, and DMF, and water-soluble solvents including methanol and ethanol, from the viewpoint of adjusting viscosity and the like.

The surface layer 16 can be formed by a method such as applying a surface layer forming composition on the outer peripheral surface of the elastic body layer 14. As the application method, various coating methods such as roll coating method, dipping method, and spray coating method can be applied. The applied surface layer 16 may be subjected to ultraviolet irradiation or heat treatment as necessary.

According to the development roll 10 having the above configuration, the elastic body layer 14 is formed of a silicone base material containing silicone rubber, and the surface layer 16 is formed of a crosslinked body of a composition containing a urethane prepolymer formed of (A) and (B) above, and (C) to (E) above, and the breaking stress of the surface layer 16 is 30 MPa or more. Therefore, the surface layer 16 has low electrical resistance, excellent wear resistance, and excellent uniformity, resulting in excellent image quality over a long period of time.

### EXAMPLES

Hereinafter, the disclosure will be described in detail using Examples and Comparative Examples.

### Example 1

### <Preparation of Material for Forming Elastic Body Layer>

A material for forming the elastic body layer was prepared by mixing conductive silicone rubber (manufactured by Shin-Etsu Chemical Co., Ltd., “X-34-264A/B, mixing mass ratio A/B=1/1”) with a static mixer.

### <Preparation of Elastic Body Layer>

As the shaft body, a solid cylindrical iron rod with a diameter of 6 mm was prepared, and an adhesive was applied to the outer peripheral surface. After setting the shaft body in the hollow space of a roll forming mold, the material for forming the elastic body layer prepared above was injected into the hollow space, heated at 190° C. for 30 minutes to cure, and then demolded. As a result, a roll-shaped elastic body layer (with a thickness of 3 mm) made of conductive silicone rubber was formed along the outer peripheral surface of the shaft body.

### <Preparation of Material for Forming Surface Layer>

To THF as a solvent, 18 parts by mass of roughness forming particles were blended and stirred for 10 minutes. Next, 100 parts by mass of the urethane prepolymer, 40 parts by mass of the carbon black (containing 21 parts by mass as carbon black) dispersed in a carbon black dispersant, 13 parts by mass of the ionic conductive agent, 8.0 parts by mass of the acrylic polymer, 15 parts by mass of the isocyanurate, and 5.0 parts by mass of the silane coupling agent were blended, and sufficiently mixed and dispersed by using a three-roll mill to prepare the material for forming the surface layer (solid content concentration: 10.8 mass %).

### <Preparation of Surface Layer>

By a roll coating method, the material for forming the surface layer was applied to the outer peripheral surface of the elastic body layer, and then heated at 155° C. for 50 minutes to cure, thereby forming the surface layer (thickness 14 μm). Through the above process, the development roll was produced.

### Examples 2 to 3, 7

In the preparation of the material for forming the surface layer, a development roll was produced in the same manner as in Example 1, except that the urethane prepolymer was changed.

### Examples 4 to 5

In the preparation of the material for forming the surface layer, a development roll was produced in the same manner as in Example 1, except that the blending amount of the acrylic polymer was changed.

### Example 6

In the preparation of the material for forming the surface layer, a development roll was produced in the same manner as in Example 1, except that carbon black not blended with a dispersant was used.

### Examples 8 to 9

In the preparation of the material for forming the surface layer, a development roll was produced in the same manner as in Example 1, except that the blending amount of carbon black was changed.

### Examples 10 to 11

In the preparation of the material for forming the surface layer, a development roll was produced in the same manner as in Example 1, except that the blending amount of isocyanurate was changed.

### Comparative Examples 1 to 3

In the preparation of the material for forming the surface layer, a development roll was produced in the same manner as in Example 1, except that the urethane prepolymer was changed.

### Comparative Example 4

In the preparation of the material for forming the surface layer, a development roll was produced in the same manner as in Example 1, except that the acrylic polymer was not blended.

### Comparative Example 5

In the preparation of the material for forming the surface layer, a development roll was produced in the same manner as in Example 1, except that isocyanurate was not used and another crosslinking agent was used.

The materials used are as follows.
Urethane prepolymer <1>: “Miractran E590” manufactured by Nippon Miractran Kogyo (thermoplastic polyurethane of aromatic isocyanate and caprolactone-based polyol, weight average molecular weight Mw 250,000, melt viscosity 2000 Pa's to 3000 Pa's)
Urethane prepolymer <2>: “Miractran E590” manufactured by Nippon Miractran Kogyo (thermoplastic polyurethane of aromatic isocyanate and caprolactone-based polyol, weight average molecular weight Mw 300,000, melt viscosity 3000 Pa's or more).
Urethane prepolymer <3>: “Miractran E590” manufactured by Nippon Miractran Kogyo (thermoplastic polyurethane of aromatic isocyanate and caprolactone-based polyol, weight average molecular weight Mw 200,000, melt viscosity less than 2000 Pas)
Urethane prepolymer <4>: the following synthesized product (thermoplastic polyurethane of aromatic isocyanate and caprolactone-based polyol, weight average molecular weight Mw 50,000)
Urethane prepolymer <5>: the following synthesized product (thermoplastic polyurethane of non-aromatic isocyanate and caprolactone-based polyol, weight average molecular weight Mw 250,000)
Urethane prepolymer <6>: “Miractran E985” manufactured by Nippon Miractran Kogyo (thermoplastic polyurethane of aromatic isocyanate and carbonate-based polyol, weight average molecular weight Mw 250,000)
Urethane prepolymer <7>: “Miractran E385” manufactured by Nippon Miractran Kogyo (thermoplastic polyurethane of aromatic isocyanate and ether polyol, weight average molecular weight Mw 250,000)
Carbon black <1>: “MHI Black #273” manufactured by Mikuni Color (dispersant: copper compound having aromatic ring), carbon black: dispersant=9.5:8.5 (mass ratio)
Carbon black <2>: “VULCAN 7HJ” manufactured by CABOT (without dispersant)
Ionic conductive agent: “Tetramethylammonium chloride” manufactured by Tokyo Chemical Industry Co., Ltd.
Acrylic polymer: the following synthesized product
Isocyanurate: “Burnock DB980K” manufactured by DIC
Other crosslinking agent: isocyanate crosslinking agent (TMP-modified TDI, “Takenate B830” manufactured by Mitsui Takeda Chemical).
Silane coupling agent: “SILQUEST A-189” manufactured by Momentive Performance Materials Japan
Roughness forming particles: “Art Pearl C800” manufactured by Negami Chemical Industrial Co., Ltd.

### <Synthesis of Urethane Prepolymer>

### (Urethane Prepolymer <4>)

Polycaprolactone diol (weight average molecular weight Mw 2000) and diphenylmethane diisocyanate were reacted at 80° C. to obtain a prepolymer. Subsequently, 1,4-butanediol was additionally added and further reacted at 80° C. to obtain the urethane polymer <4> having a weight average molecular weight Mw of 50,000.
Polycaprolactone diol: “PLACCEL 220UA” manufactured by Daicel
Diphenylmethane diisocyanate: “Cosmonate PH” manufactured by Mitsui Chemicals Polyurethanes
1,4-Butanediol: manufactured by Mitsubishi Chemical

### (Urethane Prepolymer <5>)

Polycaprolactone diol (Mw 2000) and 1,3-bis(isocyanatomethyl)cyclohexane were reacted at 80° C. to obtain a prepolymer. Subsequently, 1,4-butanediol and an amine catalyst were additionally added and further reacted at 100° C. to obtain the urethane polymer <5> having Mw of 250,000.
Polycaprolactone diol: “PLACCEL 220UA” manufactured by Daicel
1,3-Bis (isocyanatomethyl)cyclohexane: “Cosmonate 600” manufactured by Mitsui Chemicals
1,4-Butanediol: manufactured by Mitsubishi Chemical
Amine catalyst: TEDA (manufactured by Tosoh)

### <Synthesis of Acrylic Polymer>

### (Acrylic Polymer)

15 g (96 mmol) of dimethylaminopropyl acrylamide (manufactured by Kohjin Co., Ltd.), 0.92 g (0.2 mmol) of (meth)acrylate-modified silicone compound (manufactured by Shin-Etsu Chemical Co., Ltd., “X-22-174DX”), 0.38 g (3.8 mmol) of methyl methacrylate (manufactured by Junsei Chemical Co., Ltd.), 1.24 g (4 mmol) of dimethyl 1,1′-azobis (1-cyclohexanecarboxylate) (manufactured by Wako Pure Chemical Industries, Ltd., “VE-73”), and 14.35 g of methyl ethyl ketone (MEK) were charged into a 200 mL reaction flask, and after bubbling with nitrogen for 5 minutes while stirring, polymerization was performed at an internal liquid temperature of 80° C. for 7 hours. Then, 26.58 g of MEK was charged to obtain a solution containing an acrylic polymer at a solid content of 30%. The acrylic polymer is a (meth)acrylic polymer containing an amino group and a silicone group in the molecule.

### (Initial Fogging)

Each manufactured development roll was mounted as a development roll in a non-magnetic single-component electrophotographic printer (trade name “HL-4040CN”, manufactured by Brother Industries, Ltd.), and left to stand for 24 hours in each environment (HH: 32.5° C.×85% RH, LL: 15° C.×10% RH). The printer is one type of “contact-type image forming apparatus”, and the mounted development device is a so-called “contact-type development device” containing a positively charged developer. Thereafter, the paper setting of the printer was set to “plain paper thick”, the print quality was set to “standard”, and the color setting was set to “standard”, and 100 sheets of solid white image were continuously printed in the monochrome mode. Immediately after that, the setting was changed to color mode and one sheet of solid white image was printed. The degree of contamination of the solid white image printed in this color mode was visually evaluated as “fogging”. The evaluation was labeled as “∘” when there was no contamination on the entire surface of the solid white image, “Δ” when slight contamination was observed on the solid white image to an extent that posed no issue for practical use, and “x” when contamination was observed on the solid white image to an extent that was practically not usable. These evaluation results are shown as “initial fogging”.

### (Initial Halftone Image)

The printer (trade name “HL-4040CN”, manufactured by Brother Industries, Ltd.) with each manufactured development roll mounted as a development roll was connected to a personal computer and left to stand for 24 hours in a test environment (23° C., relative humidity 10%). Thereafter, the paper setting of the printer was set to “plain paper thick”, the print quality was set to “standard”, the color setting was set to “standard”, and other settings were set to “default”, and a monochrome full-surface image with a density equivalent to 18% gray was created on the personal computer screen using spreadsheet software “Excel” (Microsoft Corporation), and this monochrome full-surface image was printed as one sheet of halftone image in monochrome mode. The homogeneity of the printed halftone image was visually evaluated. The evaluation was labeled as “∘” when the halftone image was a uniform image without density unevenness, “Δ” when slight density unevenness was observed in the halftone image to an extent that posed no issue for practical use, and “x” when density unevenness was observed in the halftone image to an extent that was practically unacceptable. These evaluation results are shown in the table as “initial halftone image”.

(Fogging after Durability Test)

Each manufactured development roll was mounted as a development roll in the printer (trade name “HL-4040CN”, manufactured by Brother Industries, Ltd.), and the image quality after performing a durability printing test under the following conditions was evaluated. That is, after being left to stand for 24 hours in a low temperature and low humidity environment, the paper setting of the printer was set to “plain paper thick”, the print quality was set to “standard”, and the color setting was set to “standard”, and solid black printing was performed on 5% of the total area of one side of A4 paper for a cumulative total of 5000 sheets (cartridge life). Thereafter, fogging evaluation after the durability test was performed in the same manner as the initial fogging evaluation.

(Halftone Image after Durability Test)

Each manufactured development roll was mounted as a development roll in the printer (trade name “HL-4040CN”, manufactured by Brother Industries, Ltd.), and the image quality after performing a durability printing test under the following conditions was evaluated. Specifically, after being left to stand for 24 hours in a low temperature and low humidity environment, the paper setting of the printer was set to “plain paper thick”, the print quality was set to “standard”, and the color setting was set to “standard”, and solid black printing was performed on 5% of the total area of one side of A4 paper for a cumulative total of 5000 sheets (cartridge life). Thereafter, halftone image evaluation after the durability test was performed in the same manner as the initial halftone image evaluation.

### (Wear Resistance)

Five rolls of each manufactured development roll were prepared and mounted as development rolls in a contact-type color image forming apparatus (trade name “TN-290”, manufactured by Brother Industries, Ltd.). The developer and the developer regulating member attached to the contact-type color image forming apparatus were used as the developer and the developer regulating member. The charging properties of the developer was positive. The environment inside the contact-type color image forming apparatus with each development roll mounted was adjusted to a high humidity environment, and 5000 sheets (cartridge life) of solid white images were printed on the entire one side of A4 paper in the color printing mode. The image forming apparatus was disassembled to visually confirm whether the developer had leaked from the development device to the outside. The presence or absence of toner leakage correlates with wear resistance. The evaluation was “∘” in the case where no developer was confirmed outside the development device in all five development rolls in each of the examples and comparative examples, “Δ” in the case where a very small amount of developer was adhered around the development device in two of the five development rolls in each of the examples and comparative examples, and “x” in the case where a very small amount of developer was adhered around the development device in all five development rolls in each of the examples and comparative examples.

### (Uniformity of Surface Layer)

Evaluation was performed based on whether repelling occurred during roll coating in surface layer formation. The case where repelling occurred was labeled as “x”, and the case where repelling did not occur was labeled as “∘”.

### (Breaking Stress of Surface Layer)

A test piece was prepared by scraping off the elastic body layer and the surface layer in a composite state from the development roll, and punching out the scraped rubber piece with JIS No. 7. At the time when the measurement starts, a cut was made in the elastic body layer in advance so that the elastic body layer would break first. The tensile speed was set to 10 mm/min, and the stress (MPa) at break was measured.

### (Electrical Resistance Value of Surface Layer)

With both ends of the development roll pressed against a metal roll (diameter: 30 mm) under a predetermined load, the conductive roll was caused to rotate together by rotating the metal roll at a predetermined rotation speed. While maintaining such state (while rotating both the metal roll and the development roll), a voltage of 10 V was applied between the ends of the development roll and the metal roll, the flowing current value was measured, and the electrical resistance value (roll electrical resistance: Ω) was determined. This was expressed in LOG notation.

TABLE 1

| | Example | | | | | |
|---|---|---|---|---|---|---|
| | 1 | 2 | 3 | 4 | 5 | 6 |
| Urethane prepolymer < 1 > | 100 | — | — | 100 | 100 | 100 |
| Urethane prepolymer < 2 > | — | 100 | — | — | — | — |
| Urethane prepolymer < 3 > | — | — | 100 | — | — | — |
| Urethane prepolymer < 4 > | — | — | — | — | — | — |
| Urethane prepolymer < 5 > | — | — | — | — | — | — |
| Urethane prepolymer < 6 > | — | — | — | — | — | — |
| Urethane prepolymer < 7 > | — | — | — | — | — | — |
| Carbon black < 1 > | 40 | 40 | 40 | 40 | 40 | — |
| Carbon black < 2 > | — | — | — | — | — | 20 |
| Ion conductive agent | 13 | 13 | 13 | 13 | 13 | 13 |
| Acrylic polymer | 8 | 8 | 8 | 15 | 2 | 8 |
| Isocyanurate (cross-linking | 15 | 15 | 15 | 15 | 15 | 15 |
| agent) | | | | | | |
| Other cross-linking agents | — | — | — | — | — | — |
| Silane coupling agent | 5 | 5 | 5 | 5 | 5 | 5 |
| Roughness forming particle | 18 | 18 | 18 | 18 | 18 | 18 |
| Surface layer breaking | 36 | 48 | 30 | 40 | 43 | 48 |
| stress[MPa] | | | | | | |
| Electrical resistance | 3.2 | 3.2 | 3.2 | 3.3 | 3.2 | 4.2 |
| [LOG Ω] | | | | | | |
| Initial fogging HH | ◯ | ◯ | ◯ | Δ | Δ | Δ |
| Initial fogging LL | ◯ | ◯ | ◯ | Δ | Δ | Δ |
| Fogging after durability | ◯ | ◯ | ◯ | Δ | Δ | Δ |
| test HH | | | | | | |
| Fogging after durability | ◯ | ◯ | ◯ | Δ | Δ | Δ |
| test LL | | | | | | |
| Initial halftone image | ◯ | ◯ | ◯ | Δ | Δ | ◯ |
| Halftone image after | ◯ | ◯ | ◯ | Δ | Δ | ◯ |
| durability test | | | | | | |
| Toner leakage (wear | ◯ | ◯ | ◯ | ◯ | ◯ | ◯ |
| resistance) | | | | | | |
| Surface layer uniformity | ◯ | ◯ | ◯ | ◯ | ◯ | ◯ |

TABLE 2

| | Example | | | | |
|---|---|---|---|---|---|
| | 7 | 8 | 9 | 10 | 11 |
| Urethane prepolymer <1> | — | 100 | 100 | 100 | 100 |
| Urethane prepolymer <2> | — | — | — | — | — |
| Urethane prepolymer <3> | — | — | — | — | — |
| Urethane prepolymer <4> | — | — | — | — | — |
| Urethane prepolymer <5> | — | — | — | — | — |
| Urethane prepolymer <6> | 100 | — | — | — | — |
| Urethane prepolymer <7> | — | — | — | — | — |
| Carbon black <1> | 40 | 60 | 20 | 40 | 40 |
| Carbon black <2> | — | — | — | — | — |
| Ion conductive agent | 13 | 13 | 13 | 13 | 13 |
| Acrylic polymer | 8 | 8 | 8 | 8 | 8 |
| Isocyanurate (cross-linking agent) | 15 | 15 | 15 | 40 | 10 |
| Other cross-linking agents | — | — | — | — | — |
| Silane coupling agent | 5 | 5 | 5 | 5 | 5 |
| Roughness forming particle | 18 | 18 | 18 | 18 | 18 |
| Surface layer breaking stress [MPa] | 50 | 30 | 40 | 40 | 32 |
| Electrical resistance [LOG Ω] | 3.2 | 3 | 6 | 3.2 | 3.2 |
| Initial fogging HH | ◯ | Δ | ◯ | Δ | Δ |
| Initial fogging LL | ◯ | ◯ | Δ | Δ | Δ |
| Fogging after durability test HH | ◯ | Δ | ◯ | Δ | Δ |
| Fogging after durability test LL | ◯ | ◯ | Δ | Δ | Δ |
| Initial halftone image | ◯ | ◯ | Δ | Δ | Δ |
| Halftone image after durability test | ◯ | ◯ | Δ | Δ | Δ |
| Toner leakage (wear resistance) | ◯ | Δ | ◯ | Δ | Δ |
| Surface layer uniformity | ◯ | ◯ | ◯ | ◯ | ◯ |

TABLE 3

| | Comparative Example | | | | |
|---|---|---|---|---|---|
| | 1 | 2 | 3 | 4 | 5 |
| Urethane prepolymer <1> | — | — | — | 100 | 100 |
| Urethane prepolymer <2> | — | — | — | — | — |
| Urethane prepolymer <3> | — | — | — | — | — |
| Urethane prepolymer <4> | 100 | — | — | — | — |
| Urethane prepolymer <5> | — | 100 | — | — | — |
| Urethane prepolymer <6> | — | — | — | — | — |
| Urethane prepolymer <7> | — | — | 100 | — | — |
| Carbon black <1> | 40 | 40 | 40 | 40 | 40 |
| Carbon black <2> | — | — | — | — | — |
| Ion conductive agent | 13 | 13 | 13 | 13 | 13 |
| Acrylic polymer | 8 | 8 | 8 | — | 8 |
| Isocyanurate (cross-linking agent) | 15 | 15 | 15 | 15 | — |
| Other cross-linking agents | — | — | — | — | 15 |
| Silane coupling agent | 5 | 5 | 5 | 5 | 5 |
| Roughness forming particle | 18 | 18 | 18 | 18 | 18 |
| Surface layer breaking stress [MPa] | 25 | 11 | 30 | 38 | 20 |
| Electrical resistance [LOG Ω] | 3.2 | 3.2 | 3.2 | 3.2 | 3.2 |
| Initial fogging HH | ◯ | ◯ | ◯ | X | Δ |
| Initial fogging LL | ◯ | ◯ | ◯ | X | Δ |
| Fogging after durability test HH | X | Δ | Δ | X | Δ |
| Fogging after durability fest LL | X | Δ | Δ | X | X |
| Initial halftone image | ◯ | ◯ | ◯ | X | Δ |
| Halftone image after durability test | X | Δ | Δ | X | Δ |
| Toner leakage (wear resistance) | X | X | X | ◯ | X |
| Surface layer uniformity | ◯ | ◯ | ◯ | X | ◯ |

In Examples 1 to 11, the surface layer is formed of a crosslinked body of a composition containing a urethane prepolymer formed of an aromatic isocyanate and a caprolactone-based polyol or a carbonate-based polyol, carbon black, a (meth)acrylic polymer containing a hydrophilic group and a silicone group in the molecule, and isocyanurate, and the breaking stress of the surface layer is 30 MPa or more. According to Examples 1 to 11, it can be understood that the image is excellent in the evaluation of fogging at initial stage and after durability, and halftone image. It can also be understood that there is no toner leakage and the wear resistance is excellent. Furthermore, the uniformity of the surface layer is also excellent. Therefore, it can be understood that the surface layer has low electrical resistance, excellent wear resistance, and excellent uniformity, and provides excellent images over a long period of time.

In contrast, in Comparative Example 1, the weight average molecular weight of the urethane prepolymer is small, and the breaking stress of the surface layer is inferior. For this reason, the wear resistance is inferior. In addition, the evaluation of fogging and halftone image after durability is poor, and the image is inferior. In Comparative Example 2, the isocyanate of the urethane prepolymer is not formed of an aromatic isocyanate. For this reason, the wear resistance is inferior. In Comparative Example 3, the polyol of the urethane prepolymer is neither a caprolactone type nor a carbonate type. For this reason, the wear resistance is inferior. In Comparative Example 4, the surface layer does not contain a (meth)acrylic polymer containing a hydrophilic group and a silicone group in the molecule. For this reason, the uniformity of the surface layer is poor, and the image is inferior from the initial stage. In Comparative Example 5, the surface layer does not contain isocyanurate. For this reason, the wear resistance is inferior. In addition, the evaluation of fogging after durability is poor, and the image is inferior.

From Examples 1, 4, 5 and Comparative Example 4, it can be understood that, with the content of the (meth)acrylic polymer containing a hydrophilic group and a silicone group in the molecule being 5.0 parts by mass or more and 10.0 parts by mass or less with respect to 100 parts by mass of the urethane prepolymer, the uniformity of the surface layer is improved and the image becomes particularly good. In addition, from Examples 1 and 6, it can be understood that by using a carbon black dispersant having an aromatic ring, the image becomes particularly good. In addition, from Examples 1, 8, and 9, it can be understood that when the carbon black amount increases, the wear resistance tends to decrease, and when the carbon black amount decreases, the electrical resistance increases and the image tends to deteriorate. In addition, from Example 1 and Comparative Example 5, it can be understood that by using isocyanurate together with a (meth)acrylic polymer containing a hydrophilic group and a silicone group in the molecule, the chargeability is improved and the image becomes particularly good.

Although the embodiments and examples of the disclosure have been described above, the disclosure is not limited to the above embodiments and examples in any way, and various modifications are possible within a range that does not deviate from the spirit of the disclosure.

What is claimed is:

1. A development roll for an electrophotographic apparatus, the development roll comprising: a shaft body; an elastic body layer, formed on an outer peripheral surface of the shaft body; and a surface layer, formed on an outer peripheral surface of the elastic body layer, wherein:
the elastic body layer is formed of a silicone base material containing silicone rubber,
the surface layer is formed of a crosslinked body of a composition containing a urethane prepolymer formed of (A) and (B) as follows and (C) to (E) as follows, and
the surface layer has a breaking stress of 30 MPa or more:
(A) aromatic isocyanate;
(B) caprolactone-based polyol or carbonate-based polyol;
(C) carbon black;
(D) (meth)acrylic polymer containing a hydrophilic group and a silicone group in a molecule; and
(E) isocyanurate.

2. The development roll for the electrophotographic apparatus as claimed in claim 1, wherein a weight average molecular weight Mw of the urethane prepolymer is 100,000 or more and 300,000 or less.

3. The development roll for the electrophotographic apparatus as claimed in claim 1, wherein (A) is diphenylmethane diisocyanate.

4. The development roll for the electrophotographic apparatus as claimed in claim 1, wherein a content of (C) is 10 parts by mass or more and 35 parts by mass or less with respect to 100 parts by mass of the urethane prepolymer.

5. The development roll for the electrophotographic apparatus as claimed in claim 1, wherein a content of (D) is 1.0 part by mass or more and 20 parts by mass or less with respect to 100 parts by mass of the urethane prepolymer.

6. The development roll for the electrophotographic apparatus as claimed in claim 1, wherein a content of (E) is 1.0 part by mass or more and 40 parts by mass or less with respect to 100 parts by mass of the urethane prepolymer.

7. The development roll for the electrophotographic apparatus as claimed in claim 1, wherein an electrical resistance of the surface layer is 1.0×10³Ω or more and 1.0×10⁶Ω or less.

8. The development roll for the electrophotographic apparatus as claimed in claim 1, wherein the hydrophilic group of (D) is an amino group or a hydroxy group.

9. The development roll for the electrophotographic apparatus as claimed in claim 1, wherein the surface layer further contains a carbon black dispersant having an aromatic ring.
